(19) United States
(12) Patent Application Publication
(10) Pub. No.: US 2026/0063962 A1
(43) Pub. Date: Mar. 5, 2026

(54) ELECTROPHORETIC DISPLAY DEVICE WITH BUILT-IN SENSOR

(71) Applicant: Korea Electronics Technology Institute, Seongnam-si (KR)

(72) Inventor: Soon Hyung Kwon, Seongnam-si (KR)

(21) Appl. No.: 19/311,862

(22) Filed: Aug. 27, 2025

(30) Foreign Application Priority Data
Aug. 29, 2024 (KR) 10-2024-0117075

(51) Int. Cl. G02F 1/1676; G02F 1/167

(52) U.S. Cl. CPC G02F 1/1676; G02F 1/167

(57) ABSTRACT

An electrophoretic display device with a built-in sensor includes an electrophoretic type display module configured to display information through reflection of light incident from outside by particles moved by an electric field. The electrophoretic display device also includes a built-in sensor disposed within a display area configured to display information in the display module. The built-in sensor is configured to sense an incidence direction of the light incident from the outside. The electrophoretic display device further includes a controller configured to control the electrophoretic type display module and the built-in sensor.

### CROSS REFERENCE TO RELATED APPLICATION

The present application claims priority to Korean Patent Application No. 10-2024-0117075, filed Aug. 29, 2024, the entire contents of which is incorporated herein for all purposes by this reference.

### TECHNICAL FIELD

The present disclosure relates to an electrophoretic display device with a built-in sensor.

### BACKGROUND

An electrophoretic display device may display information by moving colored particles in accordance with an electric field such that the colored particles reflect light incident from outside. This electrophoretic display device is also called an electronic paper display or a reflective display.

Meanwhile, display devices used in TVs, smartphones, and tablet computers are being developed in the direction of minimizing a bezel size. Additionally, electronic appliances use a plurality of sensors to provide various functions. For example, a smartphone may include a camera, a fingerprint recognition sensor, a touch sensor, etc. When an electric appliance is developed in the direction of minimizing a size, it may be difficult to dispose a sensor and a display on the same plane.

### SUMMARY

Therefore, the present disclosure has been made in view of the above problems, and it is an aspect of the present disclosure to provide an electrophoretic display device with a built-in sensor disposed beneath a display module to sense an external environment.

In accordance with an aspect of the present disclosure, an electrophoretic display device includes an electrophoretic type display module configured to display information through reflection of light incident from outside by particles moved by an electric field, a built-in sensor disposed within a display area configured to display information in the display module, the sensor being configured to sense an incidence direction of the light incident from the outside, and a controller configured to control the display module and the sensor.

In accordance with an embodiment, the sensor may include one or more of an infrared sensor, an ultrasonic sensor, a laser sensor, a microwave sensor, and a camera sensor.

In accordance with an embodiment, the display module may include a sensing path configured to allow a measurement medium of the sensor to pass therethrough, thereby allowing the sensor to sense the outside in the incidence direction of the light incident from the outside.

In accordance with an embodiment, the display module may include a base substrate having one surface and another surface opposite to the one surface, a driving circuit formed on the one surface of the base substrate, a particle layer formed on the driving circuit, the particle layer including, therein, particles with a color and a fluid allowing the particles to be movable therein, an upper electrode formed on the particle layer and configured to apply an electric field to the particle layer in accordance with a voltage variation in the driving circuit, and a cover substrate formed on the upper electrode and made of a material transparent to light in a predetermined wavelength band.

In accordance with an embodiment, the particle layer may include a plurality of capsules each including the particles and the fluid, and the sensing path may be formed by spacing the plurality of capsules apart from each other in a region where the sensor is disposed or may be formed by disposing a dummy capsule configured not to include the particles.

In accordance with an embodiment, the particle layer may include a plurality of partitions configured to partition the particles and the fluid, and the sensing path may be formed by disposing a dummy compartment configured not to include the particles in the region where the sensor is disposed or by disposing, in the region where the sensor is disposed, partitions spaced apart from each other to allow the measurement medium to pass through a space formed between the partitions.

In accordance with an embodiment, the sensor may be disposed beneath the driving circuit or may be disposed between the driving circuit and the particle layer.

In accordance with an embodiment, the upper electrode may include an upper display electrode formed to cover the region where the sensor is disposed, and an upper path electrode formed not to cover the region where the sensor is disposed, thereby forming the sensing path configured to allow the measurement medium of the sensor to pass therethrough. The driving circuit may include a lower display electrode formed to cover the region where the sensor is disposed, a lower path electrode formed not to cover the region where the sensor is disposed, thereby forming the sensing path configured to allow the measurement medium of the sensor to pass therethrough. The controller may control the display module to generate an electric field between the upper display electrode and the lower display electrode when information is to be displayed in the region where the sensor is disposed. The controller may control the display module to generate an electric field between the upper path electrode and the lower path electrode when the sensing path is to be formed in the region where the sensor is disposed.

In accordance with an embodiment, the sensor may be disposed in plural in the display area of the display module such that a plurality of sensors is spaced apart from one another. The controller may control the display module such that pixels corresponding to an information area configured to display information in the display area generate an electric field between the upper display electrode and the lower display electrode, may control the display module such that, among pixels corresponding to a background area where information is not displayed, the pixel where the sensor is disposed generates an electric field between the upper path electrode and the lower path electrode, and may control the sensors disposed at the pixels corresponding to the background area to enable the sensors to perform a measurement operation.

In accordance with an embodiment, the electrophoretic display device may further include a plurality of lower display electrodes formed between the driving circuit and the particle layer while being spaced apart from one another. The plurality of lower display electrodes may be configured to be operated by the driving circuit. The upper electrode may be formed as a single conductive layer throughout the display area.

In accordance with an embodiment, the sensor may be formed among the plurality of lower display electrodes or at a position where one of the plurality of lower display electrodes is intended to be formed. When the sensing path is to be formed in the region where the sensor is located, the controller may control the display module to generate an electric field on the lower display electrode disposed outside the sensor while being spaced apart from the sensor by a predetermined distance.

Prior to the description, it should be understood that the terms used in the specification and appended claims should not be construed as limited to general and dictionary meanings, but interpreted based on the meanings and concepts corresponding to technical aspects of the present disclosure on the basis of the principle that the inventor is allowed to define terms appropriately for best explanation.

In accordance with an embodiment of the present disclosure, the sensor disposed at the lower portion of the display module may perform sensing in a display direction of the display device.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a view showing an capsule type electrophoretic display device with a built-in sensor according to an embodiment;

FIG. 2 is a view showing a partitioned electrophoretic display device with a built-in sensor according to an embodiment;

FIG. 3 is a view showing an electrophoretic display device in which a built-in sensor is disposed beneath the display module in accordance with an embodiment;

FIG. 4 is a view showing an electrophoretic display device with a built-in sensor in which a display electrode and a path electrode are separately formed in accordance with an embodiment;

FIG. 5 is a view showing an electrophoretic display device with a built-in sensor in which a display electrode and a path electrode are formed at the same layer in accordance with an embodiment;

FIG. 6 is a view showing a plurality of sensors disposed in a display area in accordance with an embodiment;

FIG. 7 is a view showing a configuration in which a plurality of lower display electrodes is formed in a separate manner and an upper electrode is formed to have a unified structure in accordance with an embodiment; and

FIG. 8 is a view showing an electrophoretic display device in which a sensor is built among a plurality of lower display electrodes in accordance with an embodiment.

### DETAILED DESCRIPTION

Hereinafter, with reference to the attached drawings, the present disclosure will be described in detail. However, this is only illustrative and the present disclosure is not limited to specific embodiments illustratively described.

Hereinafter, an embodiment of the present disclosure will be described in detail with reference to the accompanying drawings.

An electrophoretic display device 1 according to an embodiment, in which a built-in sensor 200 is included, includes an electrophoretic type display module 100 configured to display information through reflection of light incident from outside by particles moved by an electric field, the sensor 200, which is disposed within a display area 400 configured to display information in the display module 100 and is configured to sense an incidence direction of light LT incident from the outside, and a controller 300 configured to control the display module 100 and the sensor 200.

The display module 100 may be of an electrophoretic type in which light incident upon a surface displaying information is reflected by particles to be perceived by the user. The display module 100 may also be referred to as an electronic paper display or a reflective display. The sensor 200 may perform a sensing operation toward the information display surface in the display module 100.

The electrophoretic display device 1 with the built-in sensor 200 may include one or more sensors 200. The sensor 200 may be disposed at a lower portion of the display module 100. An upper portion of the display module 100 is a portion closer to the outside with reference to a particle layer 130 configured to display information to the outside, whereas the lower portion of the display module 100 is a portion not observable from the outside with reference to the particle layer 130. Since the sensor 200 is disposed at the lower portion of the display module 100, the sensor 200 does not interfere with the user perceiving the information displayed on the display module 100. The information displayed on the display module 100 may include a character, a numeral, a symbol, a picture, etc.

The sensor 200 may include one or more of an infrared sensor 200, an ultrasonic sensor 200, a laser sensor 200, a microwave sensor 200, and a camera sensor 200. The infrared sensor 200 may include various types of sensors 200 such as a proximity sensor 200 configured to determine presence of an object using infrared rays, an optical sensor 200 configured to measure intensity of infrared light, a distance sensor 200 configured to determine the distance to an object, etc. The measurement medium of the infrared sensor 200 is electromagnetic waves in the infrared wavelength band. Similarly, the ultrasonic sensor 200 may perform measurement using ultrasonic waves, and the laser sensor 200 may perform measurement using laser beams. Meanwhile, the microwave sensor 200 and a camera may perform measurement using electromagnetic waves in predetermined frequency bands, respectively.

Since the sensor 200 is disposed at the lower portion of the display module 100, the display module 100 may include a sensing path 160 through which a measurement medium of the sensor 200 passes, allowing the sensor 200 to sense the outside in the incidence direction of light incident from the outside. The sensing path 160 is a path through which the measurement medium used by the sensor 200 for measurement passes. Only under condition that the sensing path 160 is secured, the sensor 200 disposed at the lower portion of the display module 100 may perform measurement in an upward direction of the display module 100. The sensing path 160 may be a space through which the measurement medium may be transmitted from the sensor 200 in the upward direction of the display module 100. The sensing path 160 may be formed to have a structure varying depending on the type of the measurement medium. The sensing path 160 of the display module 100 may be formed in various ways. To explain the sensing path 160, the structure of the display module 100 will be described first.

The display module 100 may include a base substrate 110 having one surface and the other surface opposite to the one surface, a driving circuit 120 formed on the one surface of the base substrate 110, the particle layer 130, which is formed on the driving circuit 120 and includes, therein, particles with a color and a fluid F allowing the particles to be movable therein, an upper electrode 140 formed on the particle layer 130 and configured to apply an electric field to the particle layer 130 in accordance with a voltage variation in the driving circuit 120, and a cover substrate 150 formed on the upper electrode 140 and made of a material transparent to light in a predetermined wavelength band.

The base substrate 110 may support the display module 100. The base substrate 110 may be formed of various materials such as glass, silicon, or other materials. The components of the display module 100 may be sequentially formed on the one surface of the base substrate 110. The sensor 200 may be formed on the one surface or the other surface of the base substrate 110.

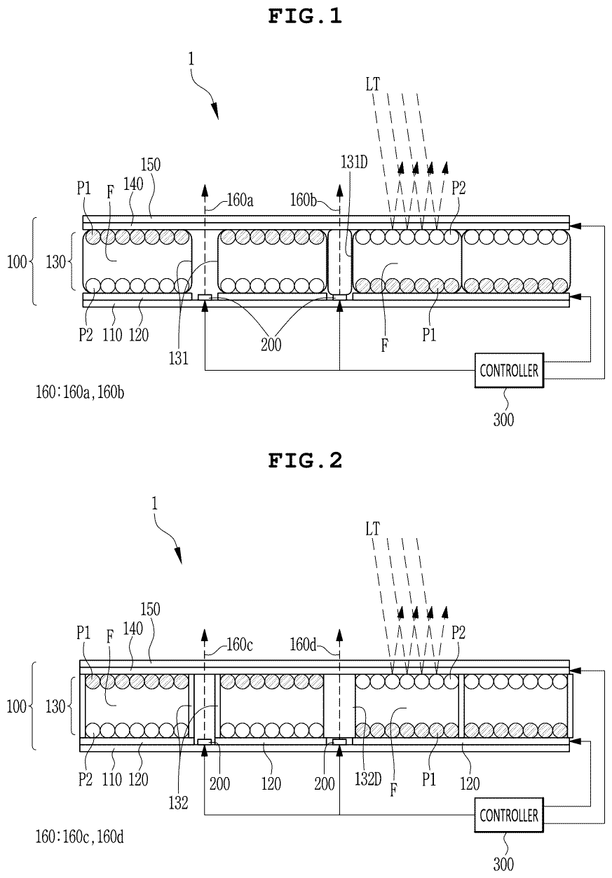

The driving circuit 120 may generate an electric field to move the particles, together with the upper electrode 140. The driving circuit 120 may be formed on the one surface of the base substrate 110. The driving circuit 120 may include a thin film transistor (TFT) and a plurality of lower electrodes formed for respective pixels PX while being spaced apart from one another. The driving circuit 120 may apply a predetermined electric field to a predetermined pixel PX under control of the controller 300. Although the driving circuit 120 is simply shown as a single layer in FIG. 1, the plurality of spaced lower electrodes is formed in the driving circuit 120 such that different voltages may be applied to respective lower electrodes.

The particle layer 130 may include a plurality of particles and a fluid F allowing the particles to be movable therein. The particle layer 130 may include two or three kinds of particles. FIG. 1 shows two kinds of particles. The particles may differ in one or more of color, size, polarity, and charge amount. For example, first particles P1 may have a first color and a positive (+) polarity, whereas second particles P2 may have a second color and a negative (−) polarity. When an electric field is applied, the first particles P1 or the second particles P2 move toward the top of the display module 100 in accordance with the direction of the electric field. In this case, accordingly, the color of the particles moved to the top of the display module 100 may be observed from the outside. The fluid F may be colorless. The fluid F may be formed of a material transparent to a sensor medium.

When the particle layer 130 includes three or more kinds of particles, first particles P1 may have a first color, a positive polarity, and a first charge amount, second particles P2 may have a second color, a positive polarity, and a second charge amount, and third particles may have a third color, a negative polarity, and a third charge amount. In this case, particles with a larger one between the first and second charge amounts tend to be aligned first in a predetermined direction. Utilizing such a phenomenon, accordingly, it may be possible to select particles to be aligned at the top of the display module 100.

The particle layer 130 may include a plurality of capsules 131 each including the particles and the fluid F. Each capsule 131 may be formed of an elastic membrane including the particles and the fluid F. The plurality of capsules 131 may be densely disposed within the particle layer 130. The capsules 131 may be made of a material transparent to light the visible spectrum.

The upper electrode 140 may generate an electric field together with the driving circuit 120 to move the particles. The upper electrode 140 may be formed on the particle layer 130. An insulating layer may be further formed between the upper electrode 140 and the particle layer 130 to provide electrical insulation. The upper electrode 140 may be a single electrically-conductive film having an integrated structure for pixels PX without separation. Alternatively, the upper electrode 140 may be formed in plural such that a plurality of upper electrodes is spaced apart from one another to apply different electric fields to different pixels PX, respectively. The upper electrode 140 may be made of a material transparent to visible light to allow external light entering the particles and light reflected from the particles to pass therethrough. The upper electrode 140 and the driving circuit 120 may be formed of a metal having electrical conductivity, indium tin oxide (ITO), or the like.

The cover substrate 150 may be formed on the upper electrode 140. The cover substrate 150 may serve to prevent impact, moisture, dust, etc. from entering the interior of the display module 100 through the top of the display module 100. The cover substrate 150 may be formed of a material transparent to visible light, similarly to the upper electrode 140. The cover substrate 150 may be formed of glass, synthetic resin, or the like.

In accordance with an embodiment, the sensing path 160 may be formed by spacing the plurality of capsules 131 apart from each other in a region where the sensor 200 is disposed or may be formed by disposing a dummy capsule 131D, which does not include the particles, in the region where the sensor 200 is disposed.

In FIG. 1, a first sensing path 160a may be formed through a space between adjacent capsules 131. During a procedure of disposing the capsules 131 on the particle layer 130, the capsules 131 may be disposed not to overlap with the region where the sensor 200 is disposed. As the adjacent capsules 131 are disposed to be spaced apart from each other, it may be possible to prevent the particles in the capsules 131 from blocking the path through which the measurement medium of the sensor 200 moves, even when the particles move in the capsules 131. Accordingly, the sensing path 160, through which the measurement medium may be transmitted, may be formed.

In FIG. 1, a second sensing path 160b may be formed through the dummy capsule 131D which does not include particles. The dummy capsule 131D may have an interior not including particles. In the procedure of disposing the capsules 131 on the particle layer 130, the dummy capsule 131D may be disposed in the region where the sensor 200 is disposed. Since the dummy capsule 131D does not include particles, the measurement medium configured to be blocked by particles may pass through the dummy capsule 131D. Thus, a sensing path 160 may be formed.

When the sensing path 160 is fixedly formed, as in the first sensing path 160a and the second sensing path 160b, there is an advantage in that the sensor 200 may perform real-time measurement because the sensing path 160 has already been formed.

It is preferable that the upper electrode 140 and the cover substrate 150, which correspond to the sensing path 160, be also formed of a material transparent with respect to the measurement medium. For example, in the case of the infrared sensor 200, the upper electrode 140, the cover substrate 150, the capsules 131, and the fluid F may be formed of a material transparent to light in the infrared wavelength band.

The sensor 200 may be disposed on the base substrate 110 and may be included in the driving circuit 120. The sensor 200 may be formed on the driving circuit 120 and may also be disposed between adjacent capsules 131. The sensor 200 may be disposed at various positions depending on the kind and size thereof. For example, in FIG. 1, the sensor 200 may be disposed on the one surface of the base substrate 110 and may be disposed within the driving circuit 120. When the sensor 200 is small in size, the sensor 200 may be formed simultaneously with the driving circuit 120 during a procedure of forming the driving circuit 120 on the base substrate 110.

FIG. 2 is a view showing a partitioned electrophoretic display device with a built-in sensor 200 according to an embodiment.

The particle layer 130 may include a plurality of partitions 132 configured to partition the particles and the fluid F. The partitions 132 may replace the capsules 131. The partitions 132 may form spaces capable of accommodating the particles and the fluid F. The partitions 132 may be formed on the driving circuit 120.

The sensing path 160 may be formed by disposing a dummy compartment, which does not include particles, in the region where the sensor 200 is disposed or by disposing, in the region where the sensor 200 is disposed, partitions 132 spaced apart from each other to allow the measurement medium to pass through a space formed between the partitions 132.

In FIG. 2, a third sensing path 160c may be formed through a partition compartment defined between the partitions 132 and configured not to include particles. The partition compartment may be formed to surround the region where the sensor 200 is disposed. The partition compartment may be formed by preventing the particles and the fluid F from filling the space defined, as the partition compartment, between the partitions 132 during a procedure of filling spaces defined by the partitions 132 with the particles and the fluid F. Since there are no particles in the space defined as the partition compartment, the sensing path 160 allowing the measurement medium, which may be blocked by the particles, to pass therethrough may be formed.

In FIG. 2, a fourth sensing path 160d may be formed through a dummy partition 132D formed of a material allowing the measurement medium to pass therethrough. The dummy partition 132D itself may be made of a material transparent with respect to the measurement medium. For example, for the infrared sensor 200, the dummy partition 132D may be formed of a material allowing infrared light to pass therethrough. Similarly, for the camera sensor 200, the dummy partition 132D may be formed of a material transparent to visible light. The dummy partition 132D may be formed to have a thickness corresponding to the region where the sensor 200 is disposed. Accordingly, when the measurement medium passes through the inside of the dummy partition 132D, a sensing path 160 is formed through the dummy partition 132D.

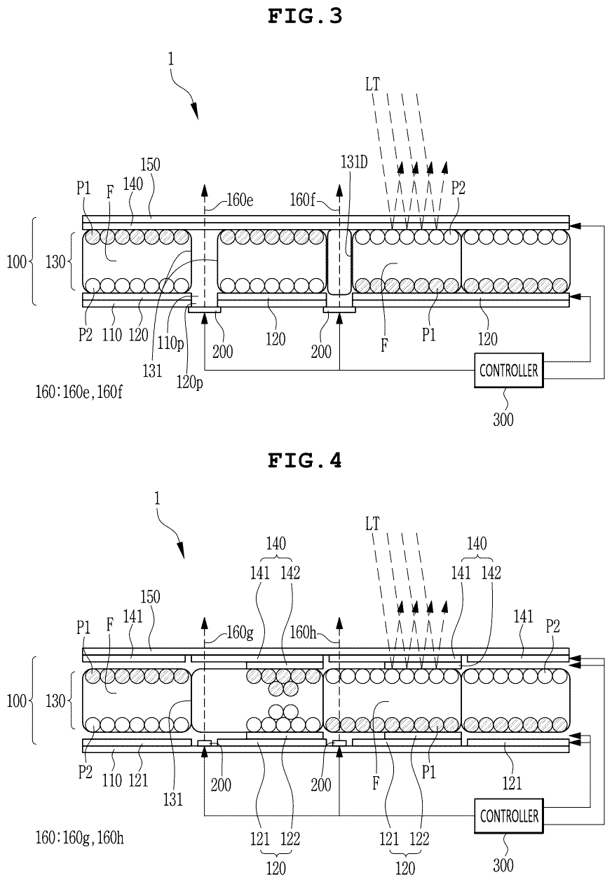

FIG. 3 is a view showing an electrophoretic display device in which a built-in sensor 200 is disposed beneath the display module 100 in accordance with an embodiment.

The sensor 200 may be disposed beneath the driving circuit 120 or may be disposed between the driving circuit 120 and the particle layer 130. In FIGS. 1 and 2, the sensor 200 is shown as being disposed at the same layer as the driving circuit 120. The position of the sensor 200 may vary depending on the kind of the sensor 200. The sensor 200 may be disposed beneath the driving circuit 120, that is, between the one surface of the base substrate 110 and the driving circuit 120. Alternatively, the sensor 200 may be disposed between the driving circuit 120 and the particle layer 130. The sensor 200 may also be disposed beneath the base substrate 110.

In FIG. 3, the sensor 200 may be disposed on the other surface of the base substrate 110. When the sensor 200 is large in size or based on characteristics of the sensor 200, the sensor 200 may be disposed on the other surface of the base substrate 110. When the sensor 200 is disposed on the other surface of the base substrate 110, there may be advantages in that a sensor 200 having a large size may be used, and an electrical connection between the sensor 200 and the controller 300 may be separately formed. In this case, open portions may be formed at the base substrate 110 and the driving circuit 120 to form the sensing path 160. The open portions formed at the base substrate 110 and the driving circuit 120 may be formed by removing portions of the base substrate 110 and the driving circuit 120 corresponding to the sensor 200. A fifth sensing path 160e or a sixth sensing path 160f may be formed through formation of the space between the capsules 131, the dummy capsule 131D, the space between the partitions 132, or the dummy partition 132D, as described with reference to FIGS. 1 and 2.

FIG. 4 is a view showing an electrophoretic display device 1 with a built-in sensor 200 in which a display electrode and a path electrode are separately formed in accordance with an embodiment.

A sensing path 160 may be formed without utilizing a space between capsules 131 or a space between partitions 132. The sensing path 160 may be formed by concentrating particles present in a capsule 131 or between partitions 132 toward one side of the capsule 131 or one of the partitions 132 and then utilizing a space where the particles are not present. The particles may move under influence of an electric field. It may be possible to concentrate the particles toward one side by modifying shapes of electrodes in the driving circuit 120 and an upper electrode 140.

The upper electrode 140 may include an upper display electrode 141 formed to cover a region where the sensor 200 is disposed, and an upper path electrode 142 formed not to cover the region where the sensor 200 is disposed, thereby forming the sensing path 160 through which the measurement medium of the sensor 200 may pass. Similarly, the driving circuit 120 may include a lower display electrode 121 formed to cover the region where the sensor 200 is disposed, and a lower path electrode 122 formed not to cover the region where the sensor 200 is disposed, thereby forming the sensing path 160 through which the measurement medium of the sensor 200 may pass.

The lower electrodes included in the driving circuit 120 and the upper electrode 140 may include a display electrode and a path electrode. The display electrode is an electrode used to move particles in order to display information on the top of the display module 100. When an electric field is generated using the display electrode, the electric field may be applied throughout the entirety of the pixel PX, thereby causing the particles to be disposed at the top of the display module 100.

On the other hand, the path electrode is an electrode used to move particles such that the particles are concentrated toward one side to form a sensing path through which the measurement medium may pass. The path electrode may be formed at a position spaced apart from the region where the sensor 200 is disposed. The path electrode may be formed not to overlap with the region where the sensor 200 is disposed. When an electric field is generated using the path electrode, particles become concentrated at a position where the path electrode is formed, without being disposed in a region where the path electrode is not formed. Accordingly, the sensor 200 may perform measurement through the sensing path 160 where particles are not present.

The display electrode and the path electrode may be disposed at upper and lower sides, respectively. An insulating layer may be further formed between the display electrode and the path electrode to provide electrical insulation. The display electrode may be formed to have a size corresponding to the size of the pixel PX, whereas the path electrode may be formed to be spaced apart from the region where the sensor 200 is disposed. In other words, the path electrode may be formed not to overlap with the region where the sensor 200 is disposed. The display electrode may include the upper display electrode 141, which is a part of the upper electrode 140, and the lower display electrode 121, which is a part of the lower electrodes in the driving circuit 120. Similarly, the path electrode may include the upper path electrode 142, which is a part of the upper electrode 140, and the lower path electrode 122, which is a part of the lower electrodes in the driving circuit 120.

When information is to be displayed in the region where the sensor 200 is disposed, the controller 300 may control the display module 100 to generate an electric field between the upper display electrode 141 and the lower display electrode 121. On the other hand, when the sensing path 160 is to be formed in the region where the sensor 200 is disposed, the controller 300 may control the display module 100 to generate an electric field between the upper path electrode 142 and the lower path electrode 122.

The controller 300 may control the display module 100 to display information on the display area 400. For example, when a character is to be displayed on the display area 400, an electric field should be generated at a pixel PX corresponding to the character so that particles of a first color are disposed at the top of the display module 100. In the case in which the sensor 200 is disposed at the pixel PX corresponding to the character, the pixel PX may not form the sensing path 160, for display of the character. The controller 300 may generate an electric field between the upper display electrode 141 and the lower display electrode 121 corresponding to the pixel PX displaying the character, thereby controlling the particles to be disposed throughout the entirety of the pixel PX. In this case, the controller 300 may stop operation of the sensor 200 because the sensing path 160 is not formed.

Conversely, when the sensor 200 is disposed at a pixel PX not corresponding to the character, the controller 300 may control the display module 100 to generate an electric field between the upper path electrode 142 and the lower path electrode 122 such that the particles concentrate in the region where the path electrode is disposed. Since forming the sensing path 160 at the pixel PX not corresponding to the character does not affect display of the character in the display area 400, this does not interfere with display of information. In this case, the controller 300 may activate the sensor 200 disposed at the pixel PX not corresponding to the character in order to perform measurement.

For example, in FIG. 4, a seventh sensing path 160g may exist in a state in which particles have moved to be concentrated toward one side. Referring to FIG. 4, it can be seen that the particles have been concentrated toward the path electrode in accordance with generation of an electric field between the upper path electrode 142 and the lower path electrode 122 by the controller 300.

Furthermore, in FIG. 4, an eighth sensing path 160h may not exist due to blocking of particles. To display information at the pixel PX corresponding to the eighth sensing path 160h, the controller 300 may generate an electric field between the upper display electrode 141 and the lower display electrode 121. In this state, the particles are disposed throughout the entirety of the upper display electrode 141, thereby blocking the measurement medium moving along the eighth sensing path 160h.

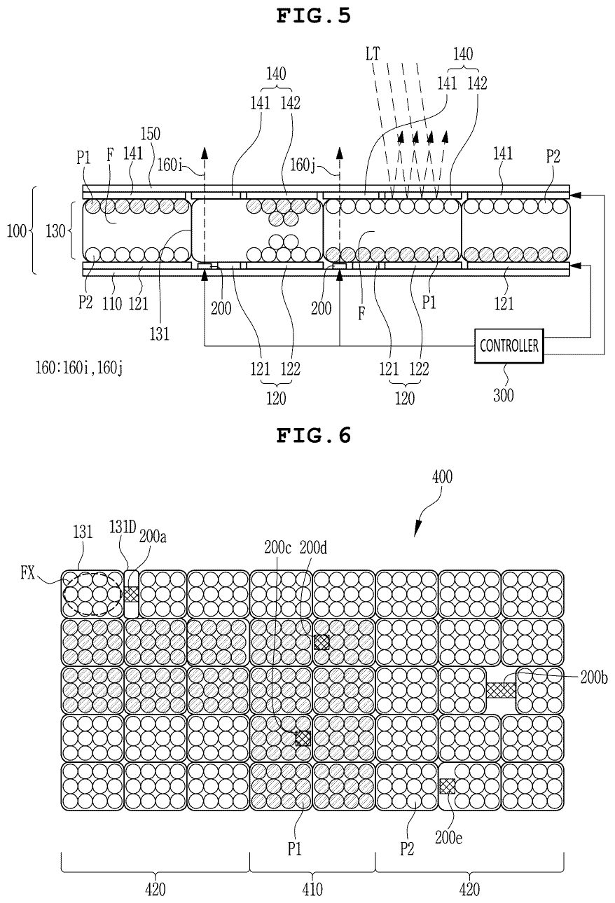

FIG. 5 is a view showing an electrophoretic display device 1 with a built-in sensor 200 in which a display electrode and a path electrode are formed at the same layer in accordance with an embodiment.

In accordance with the embodiment, the display electrode and the path electrode may be formed at the same layer. The path electrode may be formed to be separated from the region where the sensor 200 is disposed, whereas the display electrode may be formed in the remaining region where the path electrode is not formed. Only the display electrode may be formed at the pixel PX where the sensor 200 is not disposed, whereas the path electrode may be formed only at the pixel PX where the sensor 200 is disposed.

When information is to be displayed at the pixel PX where the sensor 200 is disposed, the controller 300 may control the display module 100 to generate electric fields on both the display electrode and the path electrode. When electric fields of the same size and the same direction are generated across the upper display electrode 141, the upper path electrode 142, the lower display electrode 121, and the lower path electrode 122, respectively, the particles may be moved by the electric fields such that the particles are disposed at the top of the display module 100. Accordingly, necessary information may be displayed.

When it is unnecessary to display information at the pixel PX where the sensor 200 is disposed, the controller 300 may control the display module 100 so that an electric field is formed only on the path electrodes. When an electric field is generated on the upper path electrode 142 and the lower path electrode 122, the particles may concentrate at positions where the path electrodes are formed and, as such, a sensing path 160 allowing the measurement medium to pass therethrough may be formed.

In FIG. 5, the controller 300 may generate an electric field only on the path electrodes to concentrate the particles at one side, thereby forming a ninth sensing path 160i. The controller 300 may activate the sensor 200 at which the ninth sensing path 160i exists, to perform sensing.

In FIG. 5, the controller 300 may generate electric fields on both the path electrodes and the display electrodes to position particles in a region where a tenth sensing path 160j will be formed. When particles are disposed in the region where the tenth sensing path 160j will be formed, the measurement medium will be blocked by the particles, preventing formation of the tenth sensing path 160j. In this case, accordingly, the controller 300 may not utilize the sensor 200 at which the tenth sensing path 160j does not exist, for sensing purposes.

FIG. 6 is a view showing a plurality of sensors 200 disposed in the display area 400 in accordance with an embodiment.

In the display module 100, a set of multiple pixels PX is disposed. Among the multiple pixels PX, an area where information is displayed may be referred to as an information area 410. For example, in the case of displaying characters, an area corresponding to the characters may be referred to as the information area 410. Among the plural pixels PX, an area outside the area displaying information may be referred to as a background area 420. For example, in the case of displaying characters, an area where the characters are not displayed may be referred to as the background area 420. FIG. 6 shows an enlarged view of the pixels PX. In FIG. 6, the information area 410 where first particles P1 are displayed and the background area 420 where second particles P2 are displayed are shown.

The electrophoretic display device 1 may include a plurality of built-in sensors 200. The plurality of sensors 200 may be disposed in the display area 400 of the display module 100 while being spaced apart from one another. The plurality of sensors 200 may be of the same kind or different kinds. The plurality of sensors 200 each requires a sensing path 160 for measurement. Different kinds of sensing paths 160 may be formed for the plurality of sensors 200, respectively. For example, in FIG. 6, a first sensor 200a may use a dummy capsule 131D as a sensing path 160. A second sensor 200b may use a space between capsules 131 as a sensing path 160. In FIG. 6, third, fourth, and fifth sensors 200c, 200d, and 200e may use sensing paths 160 formed through concentration of particles to one side using path electrodes. In the case of forming a sensing path 160 using path electrodes, operation of the controller 300 may vary depending on whether a sensor 200 is disposed at a pixel PX configured to display information.

The controller 300 may control the display module 100 such that each of the pixels PX corresponding to the information area 410 configured to display information in the display area 400 generate an electric field between the upper display electrode 141 and the lower display electrode 121. The controller 300 may also control the display module 100 such that, among pixels PX corresponding to the background area 420 where information is not displayed, the pixel PX where the sensor 200 is disposed generates an electric field between the upper path electrode 142 and the lower path electrode 122. Additionally, the controller 300 may control the sensors 200 disposed at the pixels PX corresponding to the background area 420 to enable the sensors 200 to perform a measurement operation.

For example, in FIG. 6, the third sensor 200c and the fourth sensor 200d are included in the information area 410 and, as such, the controller 300 may control the display module 100 to generate electric fields using the display electrodes in order to enable the pixels PX in the information area 410 to display information. As a result, the first particles P1 or the second particles P2 may be displayed on the display module 100 to display information.

Furthermore, in FIG. 6, the fifth sensor 200e is disposed in the background area 420 and, as such, the controller 300 may generate an electric field using the path electrodes to utilize the fifth sensor 200e for measurement. As a result, it can be seen that the particles are concentrated toward the path electrodes, thereby forming a sensing path 160 through which the measuring medium of the fifth sensor 200e may pass. In this case, the controller 300 may perform sensing using the fifth sensor 200e formed with the sensing path.

The controller 300 may utilize measurement data obtained using the plurality of sensors 200 in an integrated manner. For example, the controller 300 may obtain measurement results by averaging measurement values from the plurality of sensors 200. Additionally, the controller 300 may selectively use only one of the plurality of sensors 200.

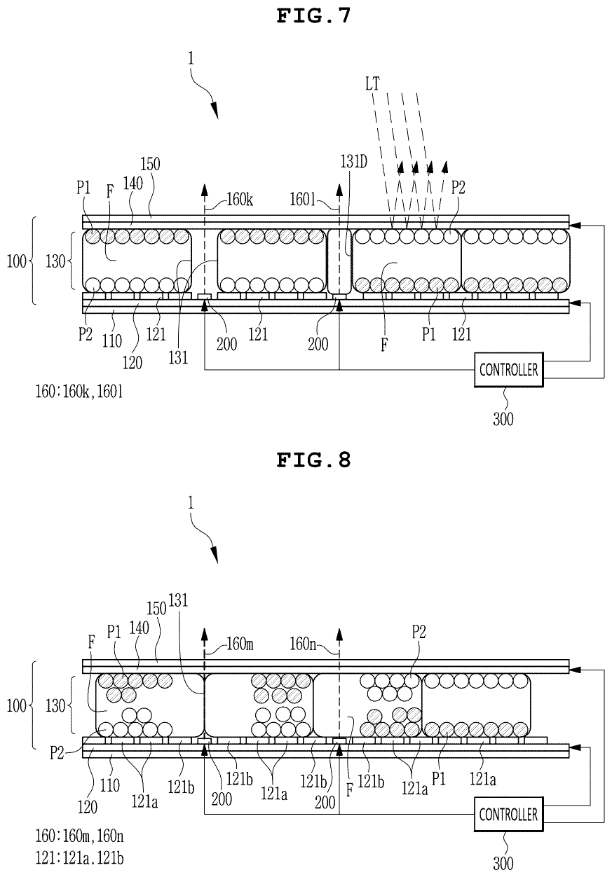

FIG. 7 is a view showing a configuration in which a plurality of lower display electrodes 121 is formed in a separate manner and an upper electrode 140 is formed to have a unified structure in accordance with an embodiment.

In accordance with an embodiment, the electrophoretic display device 1 with the built-in sensor may further include a plurality of lower display electrodes 121 formed between the driving circuit 120 and the particle layer 130 while being spaced apart from one another and configured to be operated by the driving circuit 120. An upper electrode 140 may be formed as a single conductive layer throughout a display area (“400” in FIG. 6). Each lower display electrode 121 may operate as one pixel (“FX” in FIG. 6). Each lower display electrode 121 may have a smaller size than the size of a capsule 131 or the space defined by partitions 132. That is, the size of the pixel FX may be smaller than the space defined by the capsule 131 or the partitions 132.

Differently from the structures in FIGS. 1 to 4, the lower display electrodes 121 may be formed over the driving circuit 120. Each lower display electrode 121 may generate an electric field to be applied to the upper electrode 140 and the particle layer 130. The plurality of lower display electrodes 121 may be formed to be spaced apart from one another. A voltage may be applied to the plurality of lower electrodes 121 by the driving circuit 120. The driving circuit 120 may apply or may not apply a voltage to each of the plurality of lower electrodes 121.

The sensor 200 may perform sensing through a sensing path 160k formed between capsules 131 or through a sensing path 1601 formed by a dummy capsule 131D. Similar to FIG. 2, the particle layer 130 may include partitions 132, and the sensor 200 may perform sensing through a sensing path formed between the partitions 132 or a sensing path formed through a dummy partition 132D. The upper electrode 140 is formed of a material transparent to a measurement medium. Accordingly, even when the upper electrode 140 is formed to have a single structure throughout the display area 400, the sensing path may still exist.

FIG. 8 is a view showing an electrophoretic display device 1 in which a sensor 200 is built among a plurality of lower display electrodes 121 in accordance with an embodiment.

In accordance with the embodiment, the sensor 200 may be formed among the plurality of lower display electrodes 121 or at a position where one of the plurality of lower display electrodes 121 is intended to be formed. In the case of forming a sensing path in a region where the sensor 200 is disposed, the controller 300 may control the display module 100 to generate an electric field on the lower display electrode 121 disposed outside the sensor 200 while being spaced apart from the sensor 200 by a predetermined distance.

The size of the sensor 200 may vary depending on the kind thereof. The sensor 200 may be disposed among the plurality of lower display electrodes 121. Alternatively, the sensor 200 may be formed at a position where one of the plurality of lower display electrodes 121 is intended to be formed, but is not formed. In this case, positions where sensors 200 will be formed in the display area (“400” in FIG. 6) may be irregularly distributed throughout the display area 400 irrespective of the particle layer 130.

When positions of the sensors 200 are determined irrespective of the arrangement of the particle layer 130, sensing paths may be formed in regions defined by the capsules 131 or the partitions 132, without being formed between capsules 131 or partitions 132, or through dummy capsules 131D or dummy partitions 132D.

When the sensor 200 is formed among the plurality of lower display electrodes 121, the controller 300 may control the display module 100 so that an electric field is generated only on the lower display electrode 121a disposed outside the sensor 200 while being spaced apart from the sensor 200 by a predetermined distance and no electric field is formed on the lower display electrodes 121b disposed adjacent to the sensor 200. The sensor 200 may also be formed at a position where an arbitrary one of the lower display electrodes 121 is intended to be formed. In such cases as well, the controller 300 may prevent formation of an electric field on the lower display electrodes 121b disposed within a predetermined distance from the sensor 200 and may generate an electric field only on the lower display electrodes 121a disposed farther from the sensor 200. Since the particles P1 and P2 are concentrated on the lower display electrodes 121a formed with the electric field, the sensors 200, which are surrounded by the lower display electrodes 121b where no electric field is formed, may have sensing paths 160m and 160n not blocked by the particles P1 and P2, respectively.

By using the electrophoretic display device 1 with the built-in sensor 200 according to each embodiment described above, it may be possible to manufacture an electronic appliance capable of performing sensing using an information display surface in a display thereof. Accordingly, there is no need to remove a part of the display to place the sensor 200 or to design a thick bezel for disposition of the sensor 200 in the bezel. As a result, the size of the electronic appliance may be minimized.

The present disclosure has been described in detail through specific embodiments. The above description is only an example applying the principles of the present disclosure, and other configurations may be included within the scope of the present disclosure.

1. An electrophoretic display device comprising:
an electrophoretic type display module configured to display information by reflecting light incident from outside using particles moved by an electric field;
a built-in sensor disposed within a display area of the electrophoretic type display module, the built-in sensor being configured to sense an incidence direction of the light incident from the outside; and
a controller configured to control the electrophoretic type display module and the built-in sensor.

2. The electrophoretic display device according to claim 1, wherein the built-in sensor comprises one or more of an infrared sensor, an ultrasonic sensor, a laser sensor, a microwave sensor, or a camera sensor.

3. The electrophoretic display device according to claim 1, wherein the electrophoretic type display module comprises a sensing path configured to allow a measurement medium of the built-in sensor to pass therethrough, so as to allow the built-in sensor to sense the outside in the incidence direction of the light incident from the outside.

4. The electrophoretic display device according to claim 3, wherein the electrophoretic type display module comprises:
a base substrate comprising one surface and another surface opposite to the one surface;
a driving circuit formed on the one surface of the base substrate;
a particle layer formed on the driving circuit, the particle layer comprising, therein, particles with a color and a fluid allowing the particles to be movable therein;
an upper electrode formed on the particle layer and configured to apply an electric field to the particle layer in accordance with a voltage variation in the driving circuit; and
a cover substrate formed on the upper electrode and made of a material transparent to light in a predetermined wavelength band.

5. The electrophoretic display device according to claim 4, wherein:
the particle layer comprises a plurality of capsules each including the particles and the fluid; and
the sensing path is configured to be formed by spacing the plurality of capsules apart from each other in a region where the built-in sensor is disposed or is configured to be formed by disposing a dummy capsule not containing the particles.

6. The electrophoretic display device according to claim 4, wherein:
the particle layer comprises a plurality of partitions configured to partition the particles and the fluid; and
the sensing path is configured to be formed by disposing a dummy compartment not containing the particles in the region where the built-in sensor is disposed or by disposing, in the region where the built-in sensor is disposed, partitions spaced apart from each other to allow the measurement medium to pass through a space formed between the partitions.

7. The electrophoretic display device according to claim 4, wherein the built-in sensor is disposed beneath the driving circuit or is disposed between the driving circuit and the particle layer.

8. The electrophoretic display device according to claim 4, wherein:
the upper electrode comprises:
an upper display electrode formed to cover the region where the built-in sensor is disposed; and
an upper path electrode formed not to cover the region where the built-in sensor is disposed, so as to form the sensing path configured to allow the measurement medium of the built-in sensor to pass therethrough;
the driving circuit comprises:
a lower display electrode formed to cover the region where the built-in sensor is disposed;
a lower path electrode formed not to cover the region where the built-in sensor is disposed, so as to form the sensing path configured to allow the measurement medium of the built-in sensor to pass therethrough; and
the controller is configured to:
control the electrophoretic type display module to generate an electric field between the upper display electrode and the lower display electrode in displaying information in the region where the built-in sensor is disposed, and
control the electrophoretic type display module to generate an electric field between the upper path electrode and the lower path electrode in forming the sensing path is in the region where the built-in sensor is disposed.

9. The electrophoretic display device according to claim 8, wherein:
the built-in sensor is disposed in plural in the display area of the electrophoretic type display module such that a plurality of sensors are spaced apart from one another; and
the controller is configured to:
control the electrophoretic type display module such that pixels corresponding to information area configured to display information in the display area generate an electric field between the upper display electrode and the lower display electrode,
control the electrophoretic type display module such that, among pixels corresponding to a background area where information is not displayed, the pixel where the built-in sensor is disposed generates an electric field between the upper path electrode and the lower path electrode, and
control the plurality of sensors disposed at the pixels corresponding to the background area to enable the plurality of sensors to perform a measurement operation.

10. The electrophoretic display device according to claim 4, further comprising:
a plurality of lower display electrodes formed between the driving circuit and the particle layer while being spaced apart from one another, the plurality of lower display electrodes being configured to be operated by the driving circuit; and
the upper electrode is formed as a single conductive layer throughout the display area.

11. The electrophoretic display device according to claim 10, wherein:
the built-in sensor is formed among the plurality of lower display electrodes or at a position where one of the plurality of lower display electrodes is intended to be formed; and
in forming the sensing path in the region where the built-in sensor is disposed, the controller is configured to control the electrophoretic type display module to generate an electric field on the lower display electrode disposed outside the built-in sensor while being spaced apart from the built-in sensor by a predetermined distance.
